(19) United States
(12) Patent Application Publication
(10) Pub. No.: US 2026/0253983 A1
(43) Pub. Date: Aug. 27, 2026

(54) METHOD FOR SEPARATING ELECTRODE MATERIAL FROM METAL SUBSTRATE IN LITHIUM-ION BATTERY

(71) Applicant: National Tsing Hua University, Hsinchu City (TW)

(72) Inventors: Chih-Huang LAI, Hsinchu City (TW); Chin-Lu MO, Hsinchu City (TW); Quang Luan LE, Hsinchu City (TW); Hsin-Fang CHANG, Hsinchu City (TW); Jing-Yin LIN, Hsinchu City (TW)

(73) Assignee: National Tsing Hua University, Hsinchu City (TW)

(21) Appl. No.: 19/276,488

(22) Filed: Jul. 22, 2025

(30) Foreign Application Priority Data
Feb. 24, 2025 (TW) 114106746

(51) Int. Cl. H01M 10/54; C22B 7/00; H01M 4/48; H01M 4/58; H01M 4/66; H01M 10/0525

(52) U.S. Cl. CPC H01M 10/54; C22B 7/006; H01M 4/483; H01M 4/5825; H01M 4/661; H01M 10/0525

(57) ABSTRACT

A method for separating an electrode material from a metal substrate in a lithium-ion battery includes immersing an electrode of the lithium-ion battery in a chelating solution at a temperature ranging from 20° C. to 30° C. for a time period of not less than 40 minutes. The electrode of the lithium-ion battery includes the metal substrate and the electrode material disposed on the metal substrate. The chelating solution has a pH value ranging from 6 to 9 and includes a chelating agent and a pH adjuster which are distinct components; with the proviso that when the chelating agent is an acid, the pH adjuster is not a base and vice versa, and when the pH adjuster is an organic acid, the chelating agent is not a conjugate base salt thereof.

### CROSS-REFERENCE TO RELATED APPLICATION

This application claims priority to Taiwanese Invention patent application No. 114106746, filed on Feb. 24, 2025, the entire disclosure of which is incorporated by reference herein.

### FIELD

The present disclosure relates to a lithium-ion battery, and more particularly to a method for separating an electrode material from a metal substrate in a lithium-ion battery.

### BACKGROUND

With the advancement of technology and the growing awareness of environmental protection, lithium-ion batteries have become an indispensable power source in daily life, and are widely used in consumer electronics such as mobile phones, laptops, tablets, and electric vehicles. The lithium-ion batteries bring convenience and improve quality of life; however, an increasing amount of discarded lithium-ion batteries after use causes negative impacts on the environment that cannot be ignored. Moreover, a large-scale extraction of raw materials such as lithium, cobalt, and nickel used in production of the lithium-ion batteries raises an issue of resource depletion. Therefore, how to effectively recover materials from the lithium-ion batteries, promote recycling of the materials, and reduce environmental load has become a key issue of concern to those skilled in the art.

Currently, various methods have been developed for separating and recovering an electrode material and a metal substrate in an electrode of a lithium-ion battery. In a first method, the electrode of the lithium-ion battery is placed in an organic solvent, followed by subjecting the electrode to an ultrasonic oscillation treatment, so as to separate the electrode material from the metal substrate. However, the first method is time-consuming. In a second method, the electrode of the lithium-ion battery is subjected to a pyrolysis treatment, so as to separate the electrode material from the metal substrate. However, the second method consumes a large amount of energy and results in an emission of undesirable substances, such as carbon dioxide (CO₂), volatile organic compounds, etc. In a third method, the electrode of the lithium-ion battery is immersed in a buffer solution (e.g., a citrate buffer, a phosphate buffer, and an acetate buffer) for a time period, so as to separate the electrode material from the metal substrate. Although the third method is capable of separating the electrode material from the metal substrate, the buffer solution may dissolve metal from the electrode material, leading to incomplete recovery of the electrode material or possible morphologic damage to the electrode material.

In view of the aforesaid, there is still a need to develop a method for separating an electrode material from a metal substrate in a lithium-ion battery which is energy-efficient and environmentally friendly, while also avoiding damage to components or morphology of the electrode material.

### SUMMARY

Therefore, an object of the present disclosure is to provide a method for separating an electrode material from a metal substrate in a lithium-ion battery, which can alleviate at least one of the drawbacks of the prior art.

According to the present disclosure, the method includes immersing an electrode of the lithium-ion battery in a chelating solution at a temperature ranging from 20° C. to 30° C. for a time period of not less than 40 minutes. The electrode of the lithium-ion battery includes the metal substrate and the electrode material disposed on the metal substrate. The chelating solution has a pH value ranging from 6 to 9 and includes a chelating agent and a pH adjuster. The chelating agent and the pH adjuster are distinct components; with the proviso that when the chelating agent is an acid, the pH adjuster is not a base and vice versa, and when the pH adjuster is an organic acid, the chelating agent is not a conjugate base salt thereof.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a photograph showing an electrode material and a metal substrate obtained by a method for separating the electrode material from the metal substrate in a lithium-ion battery of Example 1.

FIG. 2 is an X-ray diffraction (XRD) pattern of the electrode material in Example 1 before immersion and after sorting.

FIG. 3 is an image illustrating morphology of the electrode material in Example 1 before immersion.

FIG. 4 is an image illustrating morphology of the electrode material obtained by the method of Example 1.

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

An embodiment of a method for separating an electrode material from a metal substrate in the lithium-ion battery of the present disclosure includes immersing an electrode of the lithium-ion battery in a chelating solution at a temperature ranging from 20° C. to 30° C. for a time period of not less than 40 minutes, thereby obtaining a resultant mixture. The electrode of the lithium-ion battery includes the metal substrate and the electrode material disposed on the metal substrate. The chelating solution has a pH value ranging from 6 to 9 and includes a chelating agent and a pH adjuster. The chelating agent and the pH adjuster are distinct components. With the proviso that when the chelating agent is an acid, the pH adjuster is not a base, and vice versa, and when the pH adjuster is an organic acid, the chelating agent is not a conjugate base salt thereof. To be specific, to avoid forming a buffer solution, if the chelating agent is in an acidic form, the pH adjuster may not be the corresponding basic form of the chelating agent, and vice versa. In addition, if the pH adjuster is the organic acid, then the chelating agent may not be a conjugate base of the pH adjuster or the conjugate base salt the pH adjuster.

In some embodiments, the time period ranges from 40 minutes to 240 minutes. In some embodiments, the time period ranges from 40 minutes to 90 minutes.

### Electrode

The metal substrate is a conductor, which is used to support the electrode material, and is a current collector in the lithium-ion battery, such as a metal foil or a metal alloy foil. The metal foil may be, for example, a copper foil, or an aluminum foil.

The electrode material may be an anode material or a cathode material. The anode material includes, e.g., an anode active material. The cathode material includes, e.g., a cathode active material.

The anode active material may include, for example, a conductive carbon material. The conductive carbon material includes, but not limited to, graphite, graphene, or carbon black. The anode material may further include at least one additive. The at least one additive may include, but not limited to, an aluminum oxide material, a copper oxide material, a binder, lithium titanate, or a silicon-based material. The aluminum oxide material may include, but not limited to, aluminum oxide (Al₂O₃). The copper oxide material may include, but not limited to, copper oxide (CuO). The silicon-based material may include, but not limited to, silicon oxide (SiOₓ) or a lithium silicide material. The lithium silicide material may include lithium silicide having a fully lithiated phase of Li_{3.75}Si, lithium silicide having a fully lithiated phase of Li₁₂Si₇, or lithium silicide having a fully lithiated phase of Li₁₅Si₄.

The cathode active material may include, for example, a lithium-based oxide that contains lithium and a non-lithium metal. In some embodiments, the non-lithium metal includes, e.g., ferrum, cobalt, manganese, or nickel. The lithium-based oxide includes, for example, lithium iron phosphate (LiFePO₄), lithium cobalt oxide (LiCoO₂), lithium manganese oxide (LiMn₂O₄), lithium nickel oxide (LiNiO₂), lithium nickel manganese cobalt oxide, or lithium manganese iron phosphate (LMFP). The cathode material may further include at least one additive, and the at least one additive includes, e.g., an aluminum oxide material or a copper oxide material. The aluminum oxide material includes, but not limited to, aluminum oxide (Al₂O₃). The copper oxide material includes, but not limited to, copper oxide.

### Chelating Solution

In the present disclosure, the chelating solution is not a buffer solution. The chelating solution may react with metal ions obtained from the electrode material so as to form a functional layer (e.g., a passivation layer, an intermediate layer, etc.) between a surface of the metal substrate and the electrode material. The functional layer may facilitate peeling off the electrode material from the metal substrate. The pH adjuster is used to provide a desired pH value for the chelating solution, which renders the method of this disclosure environmentally friendly, and which mitigates damages to the electrode material caused by the chelating solution.

### Chelating Agent

The chelating agent may be a single chelating agent or a mixture of multiple chelating agents. In some embodiments, the chelating agent includes, but not limited to, a carboxylate-based chelating agent, a hydroxyl-based chelating agent, a nitrogen-based chelating agent, a phosphonate-based chelating agent, a sulfur-based chelating agent, an organometallic chelating agent, a polymeric chelating agent, a chelating surfactant, or a macrocyclic chelating agent.

The carboxylate-based chelating agent may be a single carboxylate-based chelating agent or a mixture of multiple carboxylate-based chelating agents. In some embodiments, the carboxylate-based chelating agent includes, but not limited to, citric acid, a citric acid salt, oxalic acid, an oxalic acid salt, tartaric acid, a tartaric acid salt, lactic acid, a lactic acid salt, malic acid, a malic acid salt, succinic acid, a succinic acid salt, gluconic acid, or a gluconic acid salt. The citric acid salt includes, but not limited to, sodium citrate. The oxalic acid salt includes, but not limited to, sodium oxalate, potassium oxalate, or iron (II) oxalate. The tartaric acid salt includes, but not limited to, sodium tartrate or potassium sodium tartrate. The lactic acid salt includes, but not limited to, sodium lactate, calcium lactate, or magnesium lactate. The malic acid salt includes, but not limited to, potassium malate, magnesium malate, zinc malate, or sodium malate. The succinic acid salt includes, but not limited to, calcium succinate, sodium succinate, or potassium succinate. The gluconic acid salt includes, but not limited to, sodium gluconate, calcium gluconate, ferrous gluconate, or magnesium gluconate.

The hydroxyl-based chelating agent may be a single hydroxyl-based chelating agent or a mixture of multiple hydroxyl-based chelating agents. The hydroxyl-based chelating agent includes, but not limited to, mannitol, sorbitol, or glucose.

The nitrogen-based chelating agent may be a single nitrogen-based chelating agent or a mixture of multiple nitrogen-based chelating agents. The nitrogen-based chelating agent includes, but not limited to, ethylenediaminetetraacetic acid, an ethylenediaminetetraacetic acid salt, diethylenetriamine pentaacetic acid, ethylenediamine, diethylenetriamine, triethylenetetramine, or nitrilotriacetic acid. The ethylenediaminetetraacetic acid salt includes, but not limited to, disodium ethylenediaminetetraacetate (disodium EDTA), tetrasodium ethylenediaminetetraacetate (tetrasodium EDTA), ferric sodium ethylenediaminetetraacetate (ferric sodium EDTA), or zinc disodium ethylenediaminetetraacetate (zinc disodium EDTA).

The phosphonate-based chelating agent may be a single phosphonate-based chelating agent or a mixture of multiple phosphonate-based chelating agents. The phosphonate-based chelating agent includes, but not limited to, amino tris-methylene phosphonic acid, ethylenediamine tetra-methylene phosphonic acid, 1-hydroxyethane-1,1-diphosphonic acid, [hexamethylenediamine tetra(methylenephosphonic acid)], or phytic acid.

The sulfur-based chelating agent may be a single sulfur-based chelating agent or a mixture of multiple sulfur-based chelating agents. The sulfur-based chelating agent includes, but not limited to, dimercaprol, glutathione, thioglycolic acid, or cysteine.

The organometallic chelating agent may be a single organometallic chelating agent or a mixture of multiple organometallic chelating agents. The organometallic chelating agent includes, but not limited to, a ferrocene-based material containing a chelating group or cyclopentadiene. The chelating group includes, but not limited to, a carboxyl group (—COOH), a hydroxyl group (—OH), or an amino group (—NH₂).

The polymeric chelating agent may be a single polymeric chelating agent or a mixture of multiple polymeric chelating agents. The polymeric chelating agent includes, but not limited to, a chitosan-based material, polyacrylic acid, or polyethyleneimine. The chitosan-based material includes, but not limited to, carboxymethyl chitosan, hydroxypropyl chitosan, or N-succinyl chitosan.

The chelating surfactant may be a single chelating surfactant or a mixture of multiple chelating surfactants. The chelating surfactant includes, but not limited to, sodium lauryl sulfate or alkyl polyglucoside. The alkyl polyglucoside includes, but not limited to, decyl glucoside, lauryl glucoside, caprylyl/capryl glucoside, or myristyl glucoside.

The macrocyclic chelating agent may be a single macrocyclic chelating agent or a mixture of multiple macrocyclic chelating agents. The macrocyclic chelating agent includes, but not limited to, a crown ether chelating agent. The crown ether chelating agent includes, but not limited to, 18-crown-6 or 15-crown-5.

### pH Adjuster

The pH adjuster may be a single pH adjuster or a mixture of multiple pH adjusters. In some embodiments, the pH adjuster may be an inorganic acid, an organic acid, an inorganic base, an organic amine base, an ammonium-based compound, or a metal oxide.

The inorganic acid may be a single inorganic acid or a mixture of multiple inorganic acids. In some embodiments, the inorganic acid includes boric acid, hydrochloric acid, sulfuric acid, phosphoric acid, nitric acid, hydrofluoric acid, perchloric acid, carbonic acid, or combinations thereof.

The organic acid may be a single organic acid or a mixture of multiple organic acids. In some embodiments, the organic acid includes acetic acid, citric acid, formic acid, lactic acid, malic acid, tartaric acid, oxalic acid, benzoic acid, gluconic acid, phenol, acetylacetone, formamide, glycerol, methanol, ethanol, cyclohexanol, isopropanol, tert-butanol, acetone, or combinations thereof.

The inorganic base may be a single inorganic base or a mixture of multiple inorganic bases. The inorganic base includes, but not limited to, sodium hydroxide, potassium hydroxide, calcium hydroxide, ammonia, magnesium hydroxide, lithium hydroxide, barium hydroxide, cesium hydroxide, or sodium borate.

The organic amine base may be a single organic amine base or a mixture of multiple organic amine bases. The organic amine base includes, but not limited to, triethanolamine, diethanolamine, ethanolamine, pyridine, aniline, or imidazole.

The ammonium-based compound may be a single ammonium-based compound or a mixture of multiple ammonium-based compounds. The ammonium-based compound includes, but not limited to, ammonium hydroxide, ammonium bicarbonate, or ammonium chloride.

The metal oxide may be a single metal oxide or a mixture of multiple metal oxides. The metal oxide includes, but not limited to, zinc oxide, aluminum oxide, or manganese oxide.

The method for separating the electrode material from the metal substrate in the lithium-ion battery of the present disclosure further includes a filtration step and a sorting step. In some embodiments, the filtration step involves filtrating the resultant mixture to obtain a filtrate and a solid residue including the metal substrate and the electrode material. The filtration step may be conducted using a porous filtration element (e.g., a filter bag). The porous filtration element includes, for example, a filter membrane. In the sorting step, the metal substrate and the electrode material may be sorted out from the solid residue by, e.g., using an electrostatic corona separator, or may be manually separated from the solid residue, so as to separately obtain the metal substrate and the electrode material.

The disclosure will be further described by way of the following examples. However, it should be understood that the following examples are solely intended for the purpose of illustration and should not be construed as limiting the disclosure in practice.

### Example 1

Boric acid and sodium citrate were mixed to form a chelating solution having a pH value of 6. In the chelating solution, sodium citrate had a concentration of 0.2 M.

An electrode of a lithium-ion battery was immersed in the chelating solution at 25° C. for 240 minutes to obtain a resultant mixture. The electrode of the lithium-ion battery included a Cu foil and a cathode material disposed on the Cu foil. The cathode material included LiFePO₄, Al₂O₃, and CuO.

The resultant mixture was filtered using a filter bag (industry standard) to obtain a filtrate and a solid residue. Then, the solid residue was washed by deionized water three times, followed by a sorting step to manually separate the Cu foil from the cathode material.

### Example 2

Boric acid and sodium citrate were mixed to form a chelating solution having a pH value of 7. In the chelating solution, sodium citrate had a concentration of 0.2 M.

An electrode of a lithium-ion battery was immersed in the chelating solution at 25° C. for 240 minutes to obtain a resultant mixture. The electrode of the lithium-ion battery included a Cu foil and a cathode material disposed on the Cu foil. The cathode material included LiFePO₄, Al₂O₃, and CuO.

The resultant mixture was filtered using a filter bag (industry standard) to obtain a filtrate and a solid residue. The solid residue was subjected to a sorting step so as to separately obtain the Cu foil and the cathode material. Then, the solid residue was washed by deionized water three times, followed by a sorting step to manually separate the Cu foil from the cathode material.

### Example 3

Acetic acid and sodium citrate were mixed to form a chelating solution having a pH value of 7. In the chelating solution, sodium citrate had a concentration of 0.2 M.

An electrode of a lithium-ion battery was immersed in the chelating solution at 25° C. for 240 minutes to obtain a resultant mixture. The electrode of the lithium-ion battery included a Cu foil and a cathode material disposed on the Cu foil. The cathode material included LiFePO₄, Al₂O₃, and CuO.

The resultant mixture was filtered using a filter bag (industry standard) to obtain a filtrate and a solid residue. The solid residue was subjected to a sorting step so as to separately obtain the Cu foil and the cathode material. Then, the solid residue was washed by deionized water three times, followed by a sorting step to manually separate the Cu foil from the cathode material.

### Comparative Example 1

Critic acid and sodium citrate were mixed to form a buffer solution having a pH value of 6. In the buffer solution, sodium citrate had a concentration of 0.2 M.

An electrode of a lithium-ion battery was immersed in the buffer solution at 25° C. for 240 minutes to obtain a resultant mixture. The electrode of the lithium-ion battery included a Cu foil and a cathode material disposed on the Cu foil. The cathode material included LiFePO₄, Al₂O₃, and CuO.

The resultant mixture was filtered using a filter bag (industry standard) to obtain a filtrate and a solid residue. The solid residue was subjected to a sorting step so as to separately obtain the Cu foil and the cathode material. Then, the solid residue was washed by deionized water three times, followed by a sorting step to manually separate the Cu foil from the cathode material.

### Comparative Example 2

Citric acid and sodium citrate were mixed to form a buffer solution having a pH value of 7. In the buffer solution, sodium citrate had a concentration of 0.2 M.

An electrode of a lithium-ion battery was immersed in the buffer solution at 25° C. for 240 minutes to obtain a resultant mixture. The electrode of the lithium-ion battery included a Cu foil and a cathode material disposed over the Cu foil. The cathode material included LiFePO₄, Al₂O₃, and CuO.

The resultant mixture was filtered using a filter bag (industry standard) to obtain a filtrate and a solid residue. The solid residue was subjected to a sorting step so as to separately obtain the Cu foil and the cathode material. Then, the solid residue was washed by deionized water three times, followed by a sorting step to manually separate the Cu foil from the cathode material.

### Comparative Example 3

Acetic acid and citrate acid were mixed to form a chelating solution having a pH value of 2. In the chelating solution, citrate acid had a concentration of 0.1 M.

An electrode of a lithium-ion battery was immersed in the chelating solution at 25° C. for 240 minutes to obtain a resultant mixture. The electrode of the lithium-ion battery included a Cu foil and a cathode material disposed over the Cu foil. The cathode material included LiFePO₄, Al₂O₃, and CuO.

The resultant mixture was filtered using a filter bag (industry standard) to obtain a filtrate and a solid residue. The solid residue was subjected to a sorting step so as to separately obtain the Cu foil and the cathode material. Then, the solid residue was washed by deionized water three times, followed by a sorting step to manually separate the Cu foil from the cathode material.

### Evaluation

A component loss of an electrode material (unit: wt %) was determined by analyzing the filtrate of each of Examples 1 to 3 and Comparative Examples 1 to 3 using an inductively coupled plasma device.

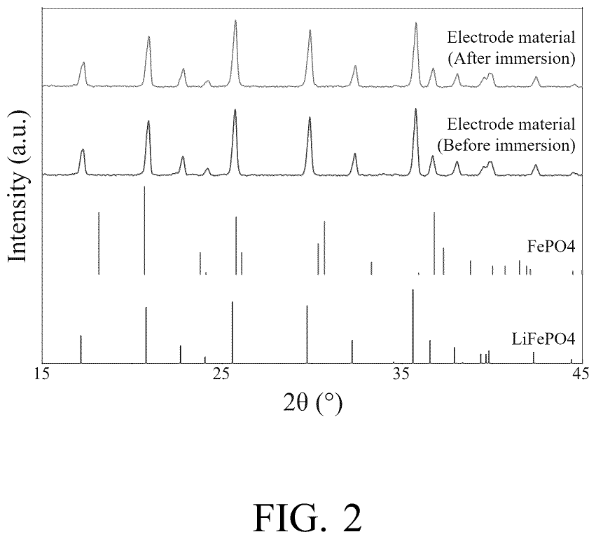

A crystal structure of the electrode material of Example 1 before immersion and after sorting was analyzed using an X-ray diffractometer, and the results are shown in FIG. 2

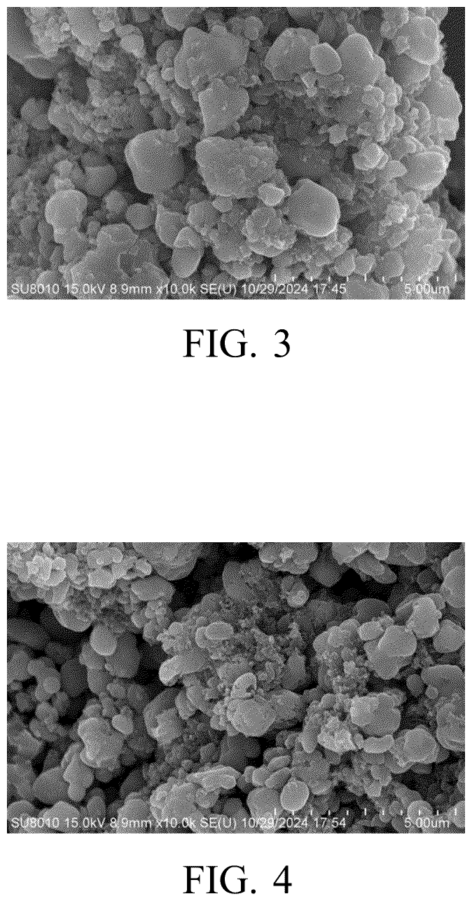

Morphology of the electrode material of Example 1 before immersion and after sorting was observed using a scanning electron microscope, and the results are respectively shown in FIG. 3 and FIG. 4.

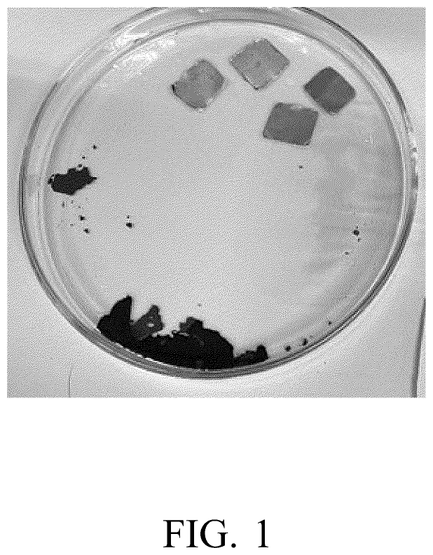

FIG. 1 is a photograph showing the electrode material and the metal substrate obtained by the method of Example 1. As shown in FIG. 1, the method for separating the electrode material from the metal substrate in the lithium-ion battery of the present disclosure is able to effectively separate the electrode material from the metal substrate.

Referring to FIG. 2, an upper spectrum represents the electrode material obtained from the method of Example 1 (i.e., after sorting), and a lower spectrum represents the electrode material of the electrode before immersion. As shown in FIG. 2, the two spectra are identical, indicating that the crystal structure of the electrode material remains unchanged after conducting the method of this disclosure. Based on this result, it is clear that the method of this disclosure does not cause damage to the electrode material and is able to maintain pristine state of the electrode material.

FIG. 3 shows morphology of the electrode material of the electrode of Example 1 before immersion, and FIG. 4 shows morphology of the electrode material obtained by the method of Example 1. The morphology images shown in FIGS. 3 and 4 are generally the same, indicating that the electrode material of Example 1 remains unchanged after conducting the method of this disclosure. Based on this result, the method of this disclosure does not cause damage to the electrode material, and is able to maintain pristine state of the electrode material.

TABLE 1

| | | Example | | | Comparative Example | | |
|---|---|---|---|---|---|---|---|
| | | 1 | 2 | 3 | 1 | 2 | 3 |
| Chelating | Chelating | Sodium | Sodium | Sodium | — | — | Critic acid |
| Solution | agent | citrate | citrate | citrate | | | |
| | pH adjuster | Boric | Boric | Acetic | | | Acetic |
| | | acid | acid | acid | | | acid |
| | pH value | 6 | 7 | 7 | | | 2 |
| Buffer | Ingredient | — | — | — | Critic acid | | — |
| Solution | | | | | and sodium | | |
| | | | | | citrate | | |
| | pH Value | | | | 6 | 7 | |
| Filtrate | Al (wt %) | 0.36 | 0.58 | 0.36 | 0.67 | 0.83 | 1.85 |
| | Cu (wt %) | 0.55 | 0.47 | 2.06 | 0.67 | 0.74 | 2.17 |
| | Li (wt %) | 0.18 | 0.20 | 0.23 | 0.39 | 0.26 | 1.16 |
| | Fe (wt %) | 1.65 | 1.52 | 3.04 | 2.39 | 1.57 | 13.07 |
| | P (wt %) | 2.92 | 2.64 | 6.94 | 5.32 | 4.03 | 13.24 |

Referring to Table 1, contents of aluminum, copper, lithium, ferrum, and phosphorus in Examples 1 and 2 are less than those in Comparative Examples 1 to 3, indicating that the method for separating the electrode material from the metal substrate in the lithium-ion battery of the present disclosure does not cause lithium-based oxide in the electrode material to dissolve from the electrode material, thereby avoiding component loss of the electrode material.

In summary, with inclusion of the specific chelating solution, the method for separating the electrode material from the metal substrate in the lithium-ion battery of the present disclosure is energy-efficient and environmentally friendly. In addition, the pristine state (e.g., morphology or components) of the electrode material can be maintained after the method is performed. Thus, an object of the present disclosure can indeed be achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, the one or more features may be singled out and practiced alone without the another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for separating an electrode material from a metal substrate in a lithium-ion battery, comprising:
immersing an electrode of the lithium-ion battery in a chelating solution at a temperature ranging from 20° C. to 30° C. for a time period of not less than 40 minutes,
wherein the electrode of the lithium-ion battery includes the metal substrate and the electrode material disposed on the metal substrate, and
wherein the chelating solution has a pH value ranging from 6 to 9 and includes a chelating agent and a pH adjuster, the chelating agent and the pH adjuster being distinct components; with the proviso that when the chelating agent is an acid, the pH adjuster is not a base and vice versa, and when the pH adjuster is an organic acid, the chelating agent is not a conjugate base salt thereof.

2. The method as claimed in claim 1, wherein the time period ranges from 40 minutes to 240 minutes.

3. The method as claimed in claim 1, wherein the chelating agent is selected from the group consisting of a carboxylate-based chelating agent, a hydroxyl-based chelating agent, a nitrogen-based chelating agent, a phosphonate-based chelating agent, a sulfur-based chelating agent, an organometallic chelating agent, a polymeric chelating agent, a chelating surfactant, a macrocyclic chelating agent, and combinations thereof.

4. The method as claimed in claim 3, wherein the carboxylate-based chelating agent is selected from the group consisting of citric acid, citrate, oxalic acid, oxalate, tartaric acid, tartrate, lactic acid, lactate, malic acid, malate, succinic acid, succinate, gluconic acid, gluconate, and combinations thereof.

5. The method as claimed in claim 3, wherein the hydroxyl-based chelating includes mannitol, sorbitol, or glucose.

6. The method as claimed in claim 3, wherein the nitrogen-based chelating agent includes ethylenediaminetetraacetic acid, a ethylenediaminetetraacetic acid salt, diethylenetriamine pentaacetic acid, ethylenediamine, diethylenetriamine, triethylenetetramine, or nitrilotriacetic acid.

7. The method as claimed in claim 3, wherein the phosphonate-based chelating agent includes amino tris-methylene phosphonic acid, ethylenediamine tetra-methylene phosphonic acid, 1-hydroxyethane-1,1-diphosphonic acid, [hexamethylenediamine tetra(methylenephosphonic acid)], or phytic acid.

8. The method as claimed in claim 3, wherein the sulfur-based chelating agent includes dimercaprol, glutathione, thioglycolic acid, or cysteine.

9. The method as claim in claim 3, wherein the organometallic chelating agent includes a ferrocene-based material containing a chelating group, or cyclopentadiene.

10. The method as claimed in claim 3, wherein the polymeric chelating agent includes carboxymethyl chitosan, hydroxypropyl chitosan, N-succinyl chitosan, polyacrylic acid, or polyethyleneimine.

11. The method as claimed in claim 3, wherein the chelating surfactant includes sodium lauryl sulfate, decyl glucoside, lauryl glucoside, caprylyl/capryl glucoside, or myristyl glucoside.

12. The method as claimed in claim 3, wherein the macrocyclic chelating agent includes 18-crown-6 or 15-crown-5.

13. The method as claimed in claim 1, wherein the pH adjuster is selected from the group consisting of an inorganic acid, an organic acid, an inorganic base, an organic amine base, an ammonium compound, metal oxide, and combinations thereof.

14. The method as claimed in claim 13, wherein the inorganic acid is selected from the group consisting of boric acid, hydrochloric acid, sulfuric acid, phosphoric acid, nitric acid, hydrofluoric acid, perchloric acid, carbonic acid, and combinations thereof.

15. The method as claimed in claim 13, wherein the organic acid is selected from the group consisting of acetic acid, citric acid, formic acid, lactic acid, malic acid, tartaric acid, oxalic acid, benzoic acid, gluconic acid, phenol, acetylacetone, formamide, glycerol, methanol, ethanol, cyclohexanol, isopropanol, tert-butanol, acetone, and combinations thereof.

16. The method as claimed in claim 1, wherein the electrode material is a cathode material that includes a cathode active material, the cathode active material including a lithium-based oxide that contains lithium and a non-lithium metal.

17. The method as claimed in claim 16, wherein the non-lithium metal of the lithium-based oxide is selected from the group consisting of ferrum, cobalt, manganese, nickel, and combinations thereof.

18. The method as claimed in claim 1, wherein the electrode material is an anode material that includes an anode active material, the anode active material including a conductive carbon material.

19. The method as claimed in claim 18, wherein the anode material further includes an additive that includes aluminum oxide, copper oxide, silicon oxide, lithium titanate, or lithium silicide.

20. The method as claimed in claim 1, further comprising the steps of:
filtering the chelating solution immersed with the electrode of the lithium-ion battery so as to obtain a filtrate and a solid residue that includes the metal substrate and the electrode material; and
separately sorting the metal substrate and the electrode material from the solid residue.
